(19) United States
(12) Patent Application Publication
(10) Pub. No.: US 2015/0348118 A1
(43) Pub. Date: Dec. 3, 2015

(54) PROTOCOL TRACKLISTING FOR DELIVERY OF INVITATIONAL CONTENT

(71) Applicant: Apple Inc., Cupertino, CA (US)

(72) Inventors: Thomas Alsina, Mountain View, CA (US); David T. Wilson, Campbell, CA (US)

(73) Assignee: Apple Inc., Cupertino, CA (US)

(21) Appl. No.: 14/289,331

(22) Filed: May 28, 2014

(51) Int. Cl. G06Q 30/02

(52) U.S. Cl. CPC G06Q 30/0269

(57) ABSTRACT

Methods and arrangements are provided for placing invitational content within a tracklist in an online media service. During a user session on an online media service, a user device is configured to play back a tracklist of one or more media items. Invitational content is interspersed within the tracklist, either between two media items, or within a single media item. A tracklist engine determines appropriate slots for invitational content to run, based on a set of tracklist rules for the best times within a tracklist for invitational content to appear. The tracklist engine then sends this invitational content slot information to an invitational content engine, which determines the most appropriate invitational content items to fit into each invitational content slot. The client device receives the invitational content from the invitational content engine, and the invitational content is played back within the corresponding invitational content slots of the current tracklist.

### TECHNICAL FIELD

The present technology pertains to streaming media services, and more specifically pertains to the generation of tracklists within a streaming media service to facilitate the delivery of invitational content.

### BACKGROUND

Online streaming media services, such as online radio, streaming music services, and streaming movie services, appeal to end users for the instant accessibility of media content, portability, and convenience. Such services also appeal to advertisers for the opportunities to cater to specific, captive audiences. Advertisers typically provide invitational content, such as a product or service advertisement, that is selected to be played in certain intervals between or in the middle of media content. A streaming music service may opt to have invitational content play after four songs are played, for example, followed by another set of four songs. Alternatively, it may be programmed to play invitational content after a song once twenty minutes has elapsed. In the case of a streaming television show, a service may be pre-programmed to display invitational content every fifteen minutes, or in specific slots that the service provider designates.

While this allows invitational content providers to present their content to end users of the service, such methods of designating advertising slots are rigid and inflexible, and aren't optimized for maximizing user engagement. For instance, if a television show has crucial “cliffhanger” moments for an advertisement break to appear, there is no way to optimize invitational content selection and placement to take into account these particular moments. Similarly, if a user is listening to a sequence of songs that are quiet, it may be jarring to intersperse the sequence with a loud piece of invitational content. Such inflexibility in placement and selection of invitational content often decreases user engagement, and decreases a sense of continuity between invitational content and media content.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for a protocol for generating tracklists within an online streaming media service. Tracklists consist of a series of one or more media items, such as text, graphics, audio, video, interactive software, or some combination thereof. Tracklists also consist of one or more invitational content slots, by which content providers, or advertisers, may disseminate invitational content to end users. The invitational content may also consist of text, graphics, audio, video, interactive software, or some combination thereof. Media items are combined and assembled into content packages, which contain the media items as well as metadata and additional information relating to the media items. Content packages may be generated on a user device, on a content delivery system accessible through a server, or some combination of the two.

Once a user of the online media service requests content to play back, the content package is assembled and generated, and the user device receives the package. The user device then generates the tracklist via a tracklist module. The tracklist is created according to a set of tracklist rules, which take into account the content package information and number of media items within the content package. The tracklist consists of media item slots containing media items, which correspond to the media items within the content package. The tracklist also consists of a number of invitational content slots, which are generated and placed according to the tracklist rules. The tracklist rules dictate where invitational contents should be placed in between, before, or after media item slots. In some embodiments, the tracklist rules may take into account the genre of the tracklist, special “cliffhanger” moments in a broadcast in which the user is particularly invested in the content, and other such considerations. In addition, specific ads may be targeted to be played only after certain songs, or on the contrary, may be prevented from playing after certain songs. Invitational content slots are then named by the tracklist module, according to a naming convention that is understood both by the user device and the content delivery system. In some embodiments, the names of the slots are descriptive, and correspond to the content considerations that were used to place the invitational content slots.

Once a tracklist is generated, invitational content must be selected to be placed within the invitational content slots. The content delivery system uses the invitational content slot names, as well as a set of slot optimizer rules, in order to select invitational content for each slot. In some embodiments, slot optimizer rules that may be taken into account include requiring that the invitational content fits thematically into the tracklist, that the volume level of the invitational content corresponds to the volume level of the tracklist, that the invitational content does not draw a user out of engagement with a media file, and more. In some embodiments, slot optimizer rules can also determine whether a single long piece of invitational content should play within a single slot, rather than several shorter pieces of invitational content playing within multiple slots.

Once the invitational content is selected, it is transmitted to the user device, placed within the invitational content slots in the tracklist, and the playback of the tracklist and media items can begin by the user.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary configuration of a client device;

FIG. 3 illustrates an exemplary method embodiment;

FIG. 4 illustrates an exemplary embodiment of a tracklist containing media item slots and invitational content slots; and

FIG. 5A and FIG. 5B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an optimized means of presenting invitational content to a user within a series of one or more media items to be played back by the user, based on rules that take into account a user's engagement with the media items. The disclosed technology provides users with invitational content that is suited for the material that the user is engaging with, and that is placed in appropriate, non-disruptive spaces within a tracklist of media content. The disclosed technology also provides advertisers with a flexible system for optimizing engagement with users of the online media service, thus increasing the potential for attention being paid to ads, and increasing the likelihood of successful advertising campaigns on the service.

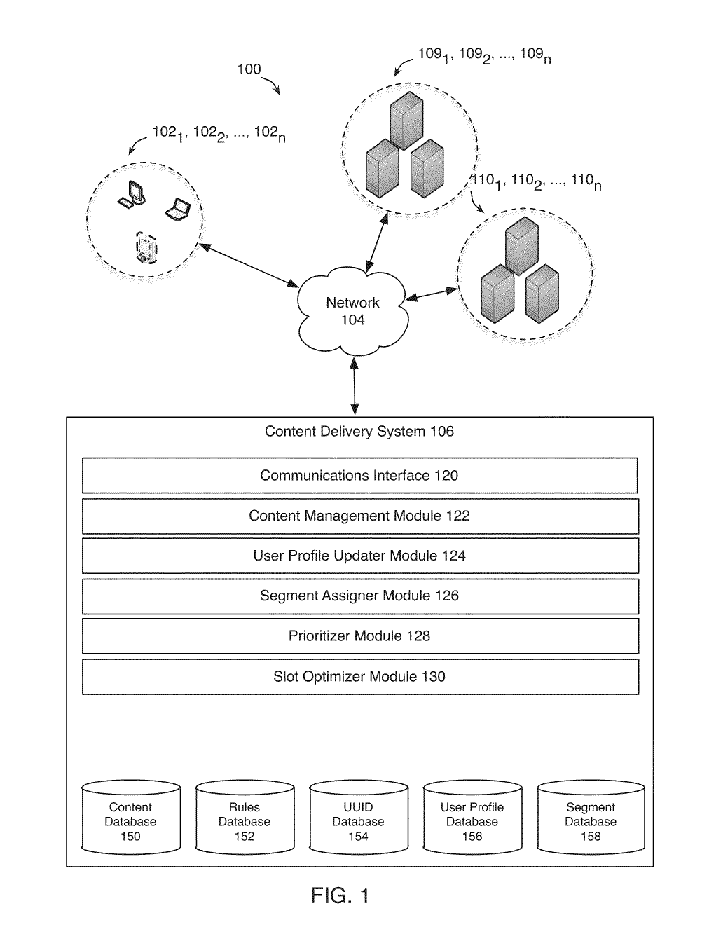

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 120.

The content delivery system 106 can include a content management module 122 to facilitate the generation of an assembled content package. Specifically, the content management module 122 can combine content from one or more primary content providers 109₁, 109₂, . . . , 109ₙ (collectively “109”) and content from one or more secondary content providers 110₁, 110₂, . . . 110ₙ (collectively “110”) to generate the assembled content package for the user terminals 102. For example, in the case of a web page being delivered to a requesting one of user terminals 102, the content management module 122 can assemble a content package by requesting the data for the web page from one of the primary content providers 109 maintaining the web page. For the invitational content on the web page provided by the secondary content providers 110, the content management module 122 can request the appropriate data according to the arrangement between the primary and secondary content providers 109 and 110. Additionally, the content management module 122 can create content packages that contain content from a single content provider. That is, a content package can contain only primary content or a content package can contain only secondary content. However, the content package is not limited to the content from content providers 109 and 110. Rather, the content package can include other data generated at the content delivery system 106. In some embodiments, the content delivery system 106 can preselect the content package before a request is received.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102ᵢ. A subsequent content package can include one or more items of invitational content that can be presented to a user of the user terminal 102ᵢ while the user interacts with the app.

Although primary and secondary providers 109 and 110 are presented herein as separate entities, this is for illustrative purposes only. In some cases, the primary and the secondary content providers 109 and 110 can be the same entity. Thus, a single entity can provide both the primary and the secondary content.

The content management module 122 can be configured to request that content be sent directly from content providers 109 and 110. Alternatively, a cached arrangement can also be used to improve performance of the content delivery system 106 and improve overall user experience. That is, the content delivery system 106 can include a content database 150 for locally storing/caching content maintained by content providers 109 and 110. The data in the content database 150 can be refreshed or updated on a regular basis to ensure that the content in the database 150 is up to date at the time of a request from a user terminal 102ᵢ. However, in some cases, the content management module 122 can be configured to retrieve content directly from content providers 109 and 110 if the metadata associated with the data in the content database 150 appears to be outdated or corrupted.

As described above, content maintained by the content providers 109 and 110 can be combined according to a predefined arrangement between the two content providers, which can be embodied as a set of rules. In an arrangement where the content delivery system 106 assembles the content package from multiple content providers, the assembly rules can be stored in a rules database 152 in the content delivery system 106. The content management module 122 can be configured to assemble the content package for user terminals 102 based on these rules. The rules can specify how to select content from secondary content providers 110 and primary content providers 109 in response to a request from one of user terminals 102. For example, in the case of a web page maintained by one of primary content providers 109 and including invitational content, the rules database 152 can specify rules for selecting one of the secondary providers 110. The rules can also specify how to select specific content from the selected one of secondary providers 110 to be combined with the content provided by one of primary providers 109. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a plurality of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 154 that can be used for managing sessions with the various user terminal devices 102. The UUID database 154 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 154. The content delivery system 106 can analyze the attributes of requesting devices to determine whether such requests can be attributed to the same device. Such attributes can include device or group-specific attributes.

In some embodiments, the content delivery system 106 can include a user-profile database 156. The user-profile database 156 can, at least in part, be constructed based on declared user characteristics related to one or more users. In some cases, the user-profile database may contain inferred or derived user characteristic values. The user-profile database 156 can be updated using a user-profile-updater module 124. In some embodiments, the user-profile-updater module 124 can be configured to add additional profile data, update profile data, fill in missing profile data, or infer user characteristic values from declared data.

The user-profile-updater module 124 can also be configured to maintain the user profile database 156 to include only more recently acquired data or to re-derive any inferred characteristics in order to ensure that the user profile is an accurate reflection of the current state of the user (location, state of mind, behaviors, demographics, etc. can change rapidly). For example, the user-profile-updater module 124 can be configured to maintain the user profile database 156 to include only data from the last two to three months. However, the user-profile-updater module 124 can be configured to adjust the data in the user profile database 156 to cover any span of time. In some instances the user-profile-updater module 124 can update the profile database 156 in real-time. Alternatively, the user-profile-updater module 124 can be configured to set an expiration period on a subset of the data in the user profile database 156. For example, a policy can specify that user declared data is maintained as long as the user account is active, but user characteristic values based on location information expire after a specified period of time. In some cases, a user can set the expiration period. In some instances, the user-profile-updater module 124 can update the user profile database 156 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 158 that is used to aid in selecting invitational content to target to users. The segment database 158 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 158 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Additional exemplary segments are described throughout this disclosure. Furthermore, targeted segments can correspond to one or more segments that content providers are likely to easily understand and thus can quickly identify as being relevant to their content. Additionally, in some embodiments, content providers 109 and 110 can define a custom targeted segment.

In some embodiments, the content delivery system 106 can provide a segment assigner module 126. The segment assigner module 126 can apply a set of user characteristics associated with a user (including segments to which a user has been previously assigned) to assign the user to one or more targeted segments. The assigner module 126 can obtain the set of user characteristic values from the user profile database 154 and/or from the user's activities during the current session. The segment assigner module 126 can assign a user to one or more defined targeted segments in the segment database 158, or alternatively, a user can be assigned to a custom targeted segment defined to meet specific goals of a content provider.

Based on the assigned segments, the user profile database 156 can be updated to reflect the segment assignments. Additionally, the content delivery system 106 can use the segment assignments to select targeted content. In some cases, the user profile data in the user profile database 156 can change over time so the segment assigner module 126 can be configured to periodically update the segment assignments in the user profile database 156. The segment assignment update can be triggered at specified intervals, upon detection of a change in the user profile database 156, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 110 can explicitly request that the content delivery system 106 prioritize the targeted segments or the request can be implicit as part of a request for a content package. The resulting prioritized list can be provided, for example, to the content management module 122, which can then use the information to assemble and deliver a content package. Additionally, the prioritized list can be stored, for example in the user profile, for later use.

In an exemplary embodiment, the content delivery system 106 is capable of receiving tracklist and slot information from the user terminal devices 102. A tracklist is a sequence of one or more pieces of media content and invitational content that is played on a user terminal device in a sequential order. An example of a tracklist can be a series of ten songs from an online music streaming library, played in succession. After the fifth song, a piece of invitational content is selected to be played on the device before the sixth song begins playing. The piece of invitational content is placed within a spot in between the fifth and sixth songs, and that spot is referred to herein as an invitational content slot. Multiple invitational content slots can exist, and invitational content within a content package can be selected to be placed within a given slot in a tracklist.

The content delivery system 106 provides a slot optimizer module 130. The slot optimizer module 130 receives a series of slot names and tracklist information from the user terminal devices 102. The user terminal devices 102 are capable of generating and running a tracklist of one or more pieces of media content, generating appropriate slots for invitational content within the sequence, and creating slot names for the slots. The user terminal devices 102 then send the slot names and tracklist information to the content delivery system 106. In some embodiments, the tracklist information can include, for example, the names of the pieces of media content in the tracklist, the lengths of the pieces of media content, a content package name, the number of invitational content slots in the tracklist, and the location of the invitational content slots within the tracklist. The slot names are descriptive names that are given to invitational content slots, and contain information that is relevant to the kind of content that should be placed in the invitational content slot. The slot name will conform to a convention that will depend on the specific embodiment, and the naming will follow a convention that is understood by both the user terminal devices 102 and the content delivery system 106.

Once the slot optimizer module 130 receives the slot names and tracklist information, it uses them to optimize the placement of content within the invitational content slots, according to a set of rules and the slot naming convention. Rules within the rules database 152 are used in a fashion as described above to select the appropriate invitational content to be placed within each invitational content slot that is received from the user terminal devices 102. The rules may consist of any method of selecting content for a given slot. For example, one rule may state that when a slot is between two quiet songs within a tracklist, a preference should be made for invitational content that is quieter than other invitational content, if possible. The names of the slots received are then read to see if the description includes quiet songs, and the tracklist information may be analyzed as well. Based on this information, if the slot is between two quiet songs, and a quiet piece of invitational content exists, then that piece of invitational content is prepared for inclusion in the content package to be generated, assembled, and sent to the user terminal device 102 that requested content. As described above, the content management module 122 can facilitate the generation and assembly of the content package.

Another example may involve the broadcast of a pre-recorded football game. A football game will have several moments in which a user may expect a commercial break or interruption of the game's broadcast to occur. Such moments can include the half-time segment of the game, timeouts that a team calls, and more. The user terminal device 102 that selects the football game for media playback sends a number of determined slots in which the user terminal device 102 has located optimal moments for invitational content to appear. The names of the slots are sent along with some tracklist information. The slots each contain a descriptive name that describes the context of the slots, and adheres to a specific convention that is understood both by the user terminal device 102 and the content delivery system 106. For example, a slot may be titled “Start of half-time segment, football game, NFL playoffs.” The slot optimizer module 130 determines whether there are any rules in the rules database 152 that address this specific situation for an invitational content slot. If specific invitational content is required or preferred by a rule, then that content is selected for the slot. The content management module 122 then generates and assembles the content package accordingly, and it is sent to the user terminal device 102 for playback within the appropriate slot.

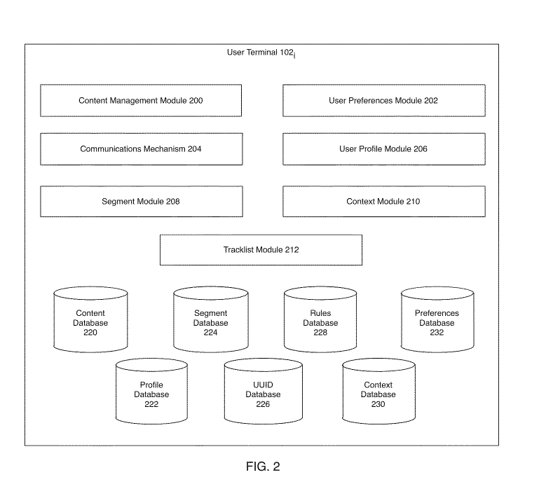

While a pre-recorded piece of media content was used as an example, it should be understood by one skilled in the art that a live streaming broadcast is also possible. The components of the user terminal devices 102 and the content delivery system 106 may operate in real time or substantially close to real time, such that a content package can be prepared for a slot at an appropriate time during a live broadcast. In some embodiments, invitational content slots are predicted ahead of time via the tracklist module 212 on the user terminal device 102. The predictive analysis may be a portion of the rules within the tracklist rules from the rules database 228. Please see FIG. 2 for an extended discussion of the tracklist module 102 and the associated tracklist rules. Once the predicted invitational content slots are sent to the content delivery system 106, with names such as “half-time show” for the predicted slots, the slot optimizer module 130 can assign invitational content for the predicted slots according to the slot optimization rules in the rules database 152. In some embodiment, existing invitational content is on standby in the content database 150, and this content can be used when appropriate within the broadcast. In this way, a live broadcast can occur with predicted slots for invitational content, such that a view watching the live broadcase will experience advertising that is contextually appropriate and programmed in substantially real time as the broadcast continues.

While the content delivery system 106 is presented with specific components, it should be understood by one skilled in the art, that the architectural configuration of system 106 is simply one possible configuration and that other configurations with more or less components are also possible. For example, the content delivery system 106 may operate without a UUID database 154 in an embodiment in which a unique user ID does not need to be stored or retrieved. For another example, a segment assigner module 126 may not be necessary in an embodiment in which segment information is not used to generate targeted content packages. In addition, some embodiments may have components from the content delivery system 106 configured to operate locally on the user device rather than on a separate server.

As described above, one aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

The disclosure now turns to FIG. 2, which illustrates an exemplary configuration of a client device. The client device, user terminal 102ᵢ, can include a content management module 200. The content management can manage and facilitate the generation and presentation of a content package. In some cases, the content management module 200 can combine content from local storage on the user terminal 102ᵢ, content delivery system 106, one or more primary content providers 109, and one or more secondary content providers 110, to generate or assemble a content package for the user terminal 102ᵢ. For example, in the case of a web page being delivered to user terminal 102ᵢ, the content management module 200 can assemble a content package by requesting the data for the web page from the content delivery system 106 or one of the primary content providers 109 maintaining the web page. For the invitational content on the web page provided by the secondary content providers 110, the content management module 200 can request the appropriate data according to the arrangement between the primary and secondary content providers 109 and 110. In some cases, the content management module 200 can request the appropriate data based on various parameters, conditions, rules, circumstances, or preferences at user terminal 102ᵢ or content delivery system 106.

Additionally, the content management module 200 can create content packages that contain content from a single content provider. That is, a content package can contain only primary content or a content package can contain only secondary content, for example. However, the content package is not limited to the content from content providers 109 and 110. Rather, the content package can include other data generated at the content delivery system 106 or user terminal 102ᵢ. For example, the user terminal 102ᵢ can include a content database 220 for locally storing/caching content maintained by user terminal 102ᵢ, content delivery system 106, or content providers 109 and 110. The data in the content database 220 can be refreshed or updated on a regular basis to ensure that the content in the database 220 is up to date at the time of a request from user terminal 102ᵢ. However, in some cases, the content management module 200 can be configured to retrieve content directly from content providers 109 and 110 if the metadata associated with the data in the content database 220 appears to be outdated or corrupted, for example.

In some embodiments, the content management module 200 can include content-listing functions. The content-listing functions can generate and/or maintain lists of content items, such as invitational content, that are estimated to be of interest to a user. The content-listing functions can also generate and/or maintain lists of places of interest for a user. The items in any particular list generated or maintained by the content-listing functions can be selected based on location data associated with the user terminal 102ᵢ, as well as context, profile, segment, or preferences information as further described below. For example, the content-listing functions can generate a specific list of items based on location data from user terminal 102ᵢ. The content-listing functions can also identify a geofence for the user terminal 102ᵢ based on the location data. The geofence can specify a geographic area or a perimeter, and the content-listing functions can identify and select items associated with the geographic area, for inclusion in a list of items. Thus, the list of items can include items specific to the geographic area. For example, the list of items can include advertisements for businesses located within the geographic area.

The content-listing functions can identify and/or select specific items to include in a list of items from one or more master lists of items or databases. For example, the content-listing functions can access a database containing all content items and search or filter the content items based on the determined geofence or user segment to identify and/or select those content items associated with a specific segment and geographic area or perimeter specified in the geofence. The content items in the master list or database can include associations with specific businesses, people, locales, entities, or locations to enable the content-listing functions to identify content items having specific associations. In some configurations, the content items can include metadata defining their respective associations to enable the content-listing functions to search and identify content items having specific associations, as previously described. Here, the metadata of the content items can also include additional information which can be used by the content-listing functions to search, filter, identify, order, or rank the content items. For example, the metadata can include a respective, unique identifier associated with the content item; the content item's association (e.g., the relationship or association defined for that particular content item); the identity of the content item's associated place or entity; etc. As another example, the metadata can include a tag, a description of the content item or its associated place, a location of the content in storage, a location of the place(s) associated with the content item, a rank of the content item and/or the place associated with the content item, a label, a URL, a preference, an identity, a status, a category, usage information, a configuration, a capability, a playback configuration, etc.

The content-listing functions can rank or order items in any specific list of items. For example, the content-listing functions can rank items based on their specific location relative to another location, such as a current location of user terminal 102ᵢ, a predicted location of the user terminal 102ᵢ, a location of a locale, a location of a third party, a location of other devices, an identity of the user and/or the user terminal 102ᵢ, an identity of a place or locale, a history, a popularity, etc. In addition, the content-listing functions can rank items based on other factors, such as current or future context, segment information, user information, statistical information, etc.

In some configurations, the content database 220 can maintain content items for presentation at the user terminal 102ᵢ. The content database 220 can also maintain content associations with specific places, such as locales. Moreover, the content database 220 can maintain a database corresponding to specific items of content. Further, metadata can specify unique identifiers, location information, association information, ranking information, etc. The content database 220 can also maintain lists of content items filtered or selected based on specific rules or criteria. For example, the content database 220 can maintain lists of content items that are relevant to specific geographic areas, demographics, segments, circumstances, etc. The content database 220 can maintain specific content items for presentation at user terminal 102ᵢ.

User terminal 102ᵢ can select and/or present one or more items of content from the content database 220 based on a request, a preference, a rule, a condition, etc. For example, user terminal 102ᵢ can select one or more content items for presentation based on a preference in the preferences database 232, context information in the context database 230, segment information in the segment database 224, rules from the rules database 228, profile information from the profile database 222, etc.

In some embodiments, the content delivery system 106 can preselect the content package before a request is received. Yet in other embodiments, the user terminal 102ᵢ can preselect the content package, a portion of a content package, or conditions for selecting a content package, and transmit a request to the content delivery system 106 or the content database 220 accordingly.

In addition, user terminal 102ᵢ can transmit a request for content to the content delivery system 106, where the request include information to be used by the content delivery system 106 in selecting the content to be provided to user terminal 102ᵢ. Alternatively, the user terminal 102ᵢ or a particular application of user terminal 102ᵢ, for example, can create a request to content management module 200 for presentation of content, where the request includes information for selecting such content. Such information included in a request can include, among other things, location information, profile information, segment information, campaign information, user information, encrypted information, timing or delivery information, preferences, context information, device information, context information, rules, etc. In some embodiments, user terminal 102ᵢ can transmit location information to the content delivery system 106, which can assist the content delivery system 106 in selecting invitational content or a content package to be delivered to user terminal 102ᵢ. User terminal 102ᵢ can also obtain location information from one or more components of the device, and use that information to select one or more content items from the content database 220.

In other embodiments, user terminal 102ᵢ can transmit segment information to the content delivery system 106, to assist the content delivery system 106 in delivering targeted content to user terminal 102ᵢ based on the segment information. Likewise, user terminal 102ᵢ can also obtain segment information from the segment database 224, and use that information to select one or more content items from the content database 220. The segment information in the segment database 224 can be generated by segment module 208 or otherwise obtained from a separate device, such as content delivery system 106.

The segment module 208 can apply a set of user characteristics associated with a user (including segments to which a user has been previously assigned) to assign the user to one or more targeted segments. The segment module 208 can obtain the set of user characteristic values from the user profile database 222, from the user's activities during the current session, from user activities in a user history, from the context database 230, etc. The segment module 208 can assign a user to one or more defined targeted segments in the segment database 224, or alternatively, a user can be assigned to a custom targeted segment defined to meet specific goals of a content provider or campaign.

Based on the assigned segments, the user profile database 222 can be updated to reflect the segment assignments. Additionally, the user terminal 102ᵢ can use the segment assignments to select targeted content from the content database 220 or to request content from a separate device, such as content delivery system 106. In some cases, the user profile data in the user profile database 222 can change over time so the segment module 208 can be configured to periodically update the segment assignments in the user profile database 222. The segment assignment update can be triggered at specified intervals, upon detection of a change in the user profile database 222, and/or upon detection of a specified activity in the user terminal 102ᵢ. In some cases, a user can be assigned to more than one segment, and each segment can be ranked or ordered. Moreover, segments in the segment database 224 can also be prioritized as described above in FIG. 1.

The context database 230 can store information associated with a user's current context. For example, the context database 230 can store the current application or device usage information, browsing information, user activity, type of content being consumed by the user, user location information, user or device state or status, user movement, device information, etc. In some cases, the context database 230 can also store information associated with a predicted context of a user, such as a future context at a specific day and/or time. For example, the context database 230 can store information defining a predicted location of the user at a future time or information associated with a predicted interest or state of the user at the future time. In some cases, the information in the context database 230 can be used to assign or prioritize segments as previously mentioned. The information in the context database 230 can also be used to select content from the content database 220 or a remote content database, request content from a remote device, rank content, assemble content, etc. In some cases, the information from the context database 230 can also be combined with information obtained from the preferences database 232, the rules database 228, the segment database 224, the profile database 222, etc., to assign or prioritize segments, select content from the content database 220 or a remote content database, request content from a remote device, rank content, assemble content, etc. Moreover, the context module 210 can collect, analyze, manage, modify, and store the context information in the context database 230. For example, the context module 210 can monitor or log user activities, and generate context information for storage in the context database 230.

User terminal 102ᵢ can also include a user preferences module 202. The user preferences module 202 can allow a user to customize user preferences to his or her needs, filter the amount and type of content to be received by a user at user terminal 102ᵢ, etc. In some cases, users may be given the opportunity to opt-in or opt-out of receiving specific types of advertising, such as proximity-based advertising, for example.

In some cases, users may set preferences specifying a distance that defines a maximum or minimum proximity to a targeted establishment. To this end, the users may specify that they wish to only receive content associated with establishments or entities located within a specific distance of the user's current or future location. Examples include 0.5 miles, 1 mile, 2 miles, and 5 miles. Users in densely populated areas, or who are walking through a mall with many stores in close proximity to each other, may opt for a much shorter proximity range, in order to avoid being inundated with content that is outside the scope of their walking or commuting proximity while at a given user location point. In some embodiments, automatic ranging based on location and/or density of content providers can also be provided, rather than a user manually adjusting the details of proximity distance.

In some cases, user preferences can include a taxonomy of offers that a user wishes to receive. This can indicate that only specific product and service categories should be received. The taxonomy can be a set of verticals, or markets in which vendors offer goods or services, that a user allows engagement with. For example, a user may decide to receive content related to fine dining restaurants and retail shopping, but not from entertainment venues or bars. Here, the user can specify these preferences within the user preferences module 202. In some embodiments, the taxonomy can become more granular and specific as a user visits specific places. For example, if a user has been demonstrated to visit or engage with invitational content from entertainment venues at a threshold frequency, the taxonomy can allow the user to specify additional user preferences for allowing or disallowing invitational content from nightclubs, sports arenas, concert halls, movie theaters, and the like. In this way, the taxonomy can be dynamic and can learn from past behavior or preferences, and can also zoom-in on the categories of interest to expand the options for the user. However, in some embodiments, the user may also be able to turn off the use or presentation of subcategories or the dynamic learning of the taxonomy.

User preferences can also be used to determine how often offers may be received by a user, and when those offers may be received. The user preferences module 202 can limit offer notifications to only be displayed during certain hours of the day. For instance, in one embodiment a user may specify that invitational content should only be broadcasted between 9 AM and 8 PM on any given day, or one or more specified days. In another embodiment, a user may specify that invitational content should be received when the user is present in his office building or in a commercial venue, for example.

Rate throttling can also be an additional consideration. For example, a user can specify that no more than a set number of offers should be broadcasted or delivered in a given span of time, or in total. To illustrate, the user can specify that only up to a maximum of 5 offers should be delivered to that user in a week. The throttling can also, in some case, be coupled with other settings such as frequency settings. For example, the user can specify that only a maximum of 5 offers should be delivered in a week, but each offer should be at least 5 minutes apart or, alternatively, each offer should be no more than 5 minutes apart.

In some embodiments, a user can choose to “blacklist” a particular invitational content provider from broadcasting to them. In additional embodiments, a user can specify that the same invitational content provider should not broadcast to the user again for a specified period of time, e.g., ten minutes, one hour, one day, etc.

The user profile module 206 can store the preferences in the user preferences database 232. The preferences in the user preferences database 232 can also be associated with user profiles stored in the profile database 222.

The profile database 222 can store any profile information created and stored by the user profile module 206. The profile information can include profiles created for one or more users, devices, or accounts. The profiles can include information such as, for example, a user name, a user ID, address information for the user, user preferences or a reference to user preferences stored elsewhere (e.g., user preferences database 222), a user alias, contact information, identifying information, or any other profile information according to conventional profile methods.

The UUID database 226 can also store a unique user ID representing a user. The unique user ID can represent a user profile in the profile database 222. In some cases, the unique user ID can be used to identify a user without disclosing private information about the user, such as the user's name or social security number, for example.

The information in the various databases can be communicated to the content delivery system 106 through the network 104. To facilitate communications with the content delivery system 106 and/or any other device or component, the user terminal 102ᵢ can include a communications interface 120.

In some cases, however, information is maintained at the user terminal 102ᵢ to protect the user's privacy. Moreover, certain information transmitted from user terminal 102ᵢ to a separate device, such as content delivery system 106, can be degraded, encrypted, or otherwise hidden or protected for privacy reasons. For example, to protect the user's privacy interest in his or her current location, user terminal 102ᵢ can ensure to obscure location information sent to content delivery system 106.

Moreover, information sent to a server, such as content delivery system 106, can be obscured, concealed, or encrypted in many ways. For example, a portion of the information sent to the server can be omitted in order to provide the server incomplete information so as to protect the precise information from being fully revealed. To illustrate, instead of sending the exact location of user terminal 102ᵢ, the location information can merely specify a vicinity, as opposed to exact coordinates, of user terminal 102ᵢ to protect the exact location of user terminal 102ᵢ. Thus, if the user associated with user terminal 102ᵢ is at church, for example, but does not want that information disclosed, the degraded location of user terminal 102ᵢ can omit such details by providing a vicinity of the user, which may not precisely place user terminal 102ᵢ at the church. As another example, strings or symbols representing particular information can be sent to a server in lieu of the actual information to conceal the actual information represented by such strings or symbols. In some embodiments, user terminal 102ᵢ can use strings or symbols to represent segments or users, and send such strings or symbols to the server instead of the actual information. For example, user terminal 102ᵢ can send to the server unique user IDs from the UUID database 226, instead of actual names or real identifying information, to conceal and protect the identity of users. As another example, user terminal 102ᵢ can send to the server a string representing a segment for targeting content to hide the actual segment represented by the string. Other methods of concealing or encrypting information are also contemplated herein; however, these are provided as examples for the sake of clarity.

The tracklist module 212 can generate a tracklist with a number of invitational content slots for pieces of media content. Once a content package is assembled, the tracklist module 212 takes the pieces of media content within the content package and places them in a sequential order by which a user can experience them during playback. The sequential order consists of tracks, or places within the tracklist where pieces of media content are played, and slots, or pieces of invitational content within the tracklist where pieces of invitational content are played. A tracklist may consist of a single track and no invitational content slots, multiple tracks and multiple invitational content slots, or any other conceivable configuration. The tracklist module 212 generates the tracklist according to a set of tracklist rules from the rules database 228, as well as tracklist metadata that is a part of the content package. The set of tracklist rules can consist of anything pertinent to the determination of how a tracklist is structured, including where the ideal spaces for slots are. Tracklist metadata can also provide information about where spaces for slots should be placed between tracks.

In some embodiments, rules can provide content providers and media providers with ways to be flexible about how content interacts within a tracklist. For example, a content provider may wish to run a single long ad at the end of a video program, rather than multiple short ads interspersed throughout. Similarly, if there is an exclusive album premiere event, then the media provider may have a stipulation that the album must be listened to without advertising interruptions. In this case, a single slot is proportioned at the end, and the information related to the slot is sent to the content delivery system 106. In some embodiments, the decisions about the sorts of invitational content to appear in the slots occur in the content delivery system 106, while the locations of slots for potential invitational content to appear is determined in the user terminal 102, via the tracklist module 212. In some instances, the tracklist module 212 may pass along slot information but the content delivery system 106 does not fill all of the slots. Rather, only a portion of the total number of slots are filled with some form of invitational content. The other slots will then contain no content and effectively disappear during playback.

In some embodiments, the user terminal device 102 can also provide information to the content delivery system about what invitational content is appropriate or inappropriate for the user terminal device 102. This can be provided by the tracklist rules, user preferences, or some combination of the two. In situations in which the invitational content is selected by the content delivery system 106 and sent back to the user device, the user device can be set up to accept or reject pieces of content that a user has specified should not be shown, or pieces of content that the device has been directed to not show. The user terminal device 102 thus has some ability to control the content that the content delivery system 106 provides. In a situation in which content from the content delivery system 106 is rejected by the user device 102, a request is sent which the slot optimizer module 130 takes into account when providing alternate invitational content for the related invitational content slots.

Once the tracklist is generated, the tracklist module 212 provides a name for each one of the slots within the tracklist. Names are generated according to a naming convention that is understood by both the content delivery system 106 and the user terminal 102. The names contain descriptions of the slot placements and contexts. For example, for a slot between two bluegrass songs in the tracklist, that genre information can be communicated in the name. These names, along with tracklist information in some embodiments, are sent to the content delivery system 106.

While the tracklist module 212 in this particular embodiment is described as being contained within the user terminal device 102, it should be understood by one skilled in the art that the full functionality of the tracklist module 212 can occur within the content delivery system 106. In such an embodiment, both the generation of the tracklist and the naming of the slots occurs on the content delivery system 106 rather than the user device. In this way, the remote server is capable of handling the intensive processing involved in generating tracklists, and the user terminal device 106 need only run a playback application that is relatively lightweight in processing.

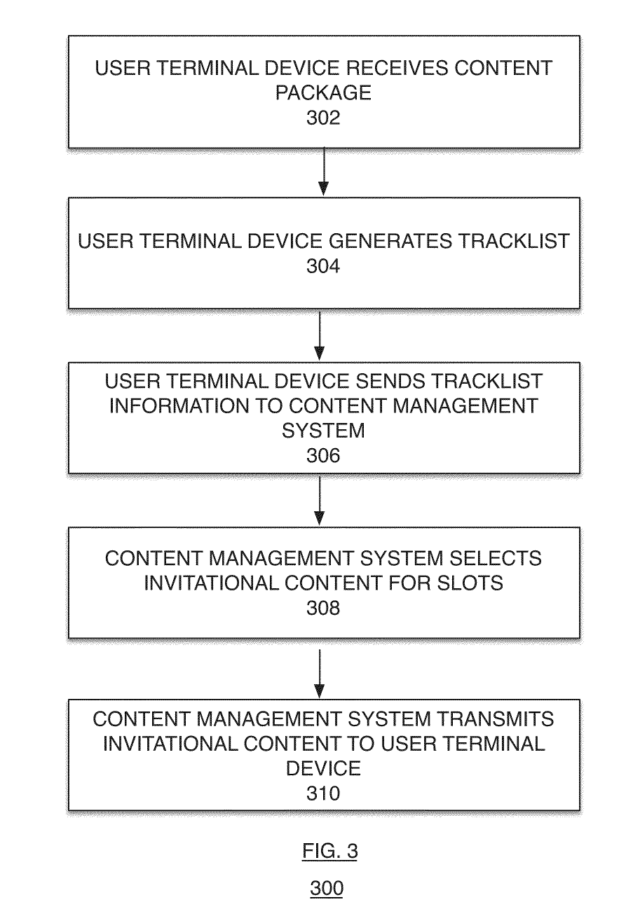

Turning now to FIG. 3, an operation of the tracklist generation and invitational content selection process will be discussed in greater detail. FIG. 3 is a flowchart of steps in an exemplary method 300 for generating a tracklist and selecting invitational content for slots within the tracklist.

Method 300 begins at step 302, where a user terminal device 102 receives a content package. The content package can be generated and assembled on the user device 102, on the content delivery system 106, or on some combination of both. The content package consists of at least one media file, along with media file information and content package information from content providers.

At step 304, the user terminal device generates a tracklist using the content package. The tracklist is a sequence in which the media file contents of the content package are meant to be played back on a user terminal device 106. The tracklist order may be determined by the content package information provided by content providers, or by tracklist rules determining the generation of the tracklist, or some combination thereof. The user terminal device 102 also invitational content slots to appear within the tracklist at appropriate points within the tracklist, and generates a name for each invitational content slot that corresponds to the context of the slot appearing within the tracklist. The name given to each invitational content slot adheres to a convention that is understood by both the user terminal device 102 and the content delivery system 106, and describes the invitational content slot in terms of the tracklist and media content of the tracklist.

At step 306, the user terminal device sends the tracklist information to the content delivery system 106, and requests invitational content for that particular tracklist. The tracklist information includes the generated name for the invitational content slots, the content of the media files within the tracklist, and other information. In some embodiments, the tracklist information includes information the genre or type of programming that a tracklist consists of. For example, in regard to a tracklist consisting of bluegrass music, the user terminal device 102 could pass along that genre data as pertinent information about the tracklist.

At step 308, the content delivery system 106 selects invitational content for each slot. This invitational content is selected according to the tracklist information and a set of slot optimization rules, which relate to what appropriate invitational content fits within each invitational content slot. In some embodiments, the slot optimization rules consist of information about whether a single longer piece of invitational content is preferred or several shorter pieces of invitational content in multiple slots is preferred. In other embodiments, the slot optimization rules consist of information about what invitational content fits within specific genres or kinds of programming within a tracklist. In still other embodiments, pieces of media adjacent to slots dictate the kinds of invitational content that are selected.

At step 310, the content delivery system 106 transmits the selected invitational content to the user terminal device 102. The invitational content is then configured to be played in the invitational content slots of the tracklist when the user device plays back the tracklist. In some embodiments, the user terminal device 102 provides information to the content delivery system about what invitational content is appropriate or inappropriate for the user terminal device 102. The user device can be set up to accept or reject pieces of content that a user has specified should not be shown, or pieces of content that the device has been directed to not show. If the transmitted invitational content is rejected by the user device 102, a request is sent which the slot optimizer module 130 takes into account when providing alternate invitational content for the related invitational content slots.

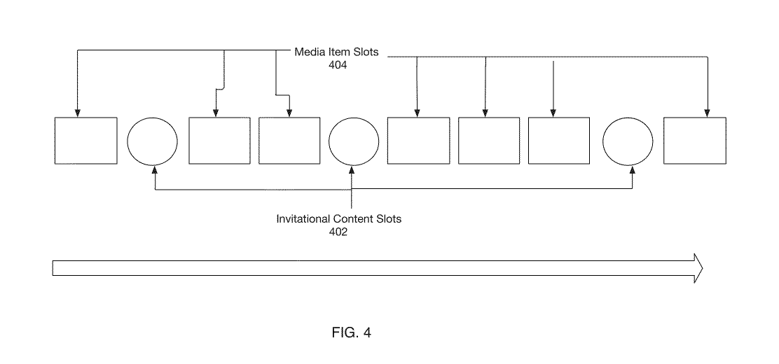

Turning now to FIG. 4, one possible embodiment of a tracklist will be discussed in detail. The more appropriate embodiment will be apparent to those of ordinary skill in the art when practicing the present technology. Persons of ordinary skill in the art will also appreciate that other system embodiments are possible.

FIG. 4 illustrates an example tracklist that is generated to be played back in sequential order on a user terminal device 102. The tracklist consists of invitational content slots 402 and media content slots 404. As described above in FIGS. 1 and 2, a tracklist is generated in order for a user experience to consist of a mixture of engagement with media items, such as songs or video, and invitational content, such as an audio advertisement from a content provider. Media items are placed within the media content slots 404 for playback, and invitational content slots 402 are determined by the tracklist module 212 based on a set of tracklist rules. Invitational content is selected for each invitational content slot by the content delivery system 106 via the slot optimizer module 130. In some embodiments, certain invitational content slots may not be filled by invitational content, in which instance the invitational content slots effectively disappear from the perspective of the user. No content is played during those slots and the playback moves on to the slot next to it.

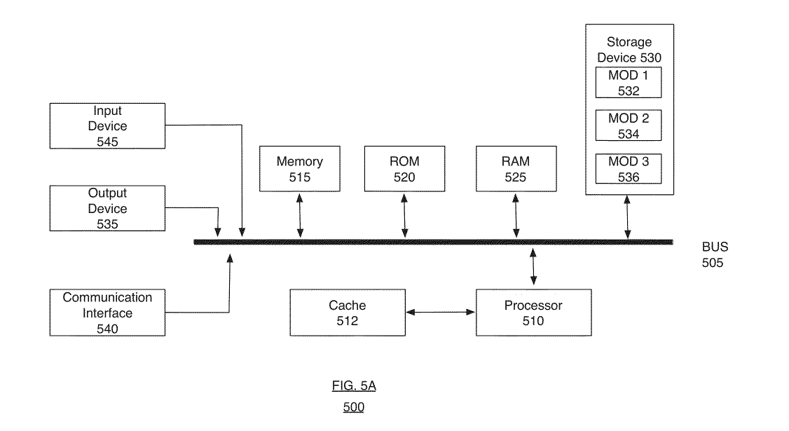

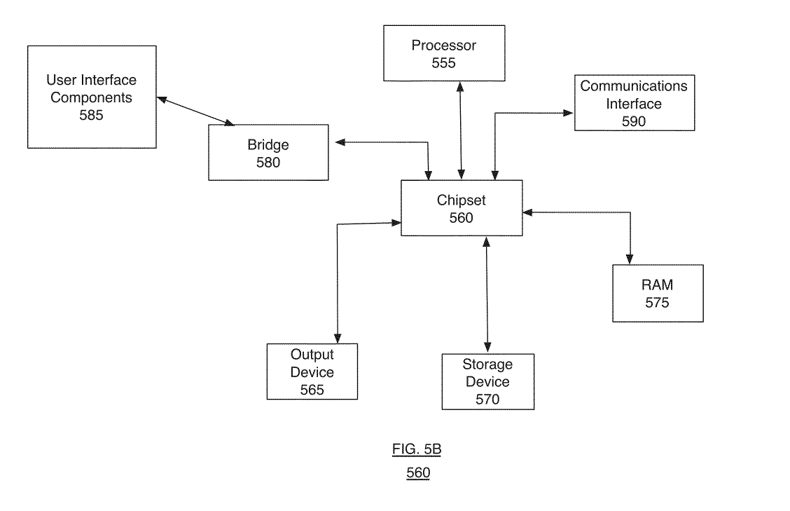

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer implemented method comprising:
receiving, via a user device, a tracklist, wherein the tracklist comprises at least one media item slot and at least one invitational content slot;
receiving, via the user device, a list of slot properties for the at least one invitational content slot;
determining, via a slot optimization engine, an invitational content item for placement in each invitational content slot within the tracklist, wherein the determining is based on the slot properties and a set of slot optimization rules for placing invitational content within invitational content slots; and
transmitting the determined invitational content items to a client device.

2. The method of claim 1, wherein the list of slot properties for the at least one invitational content slot comprises genre descriptions of the media item slots adjacent to the invitational content slot.

3. The method of claim 1, wherein the set of slot optimization rules comprises rules for associating invitational content with genres of media items.

4. The method of claim 1, wherein the transmitting the determined invitational content items to a client device comprises generating and assembling a content package containing the invitational content items for playback on the client device.

5. The method of claim 1, wherein the tracklist is a sequence of ordered slots for media items and invitational content, and wherein the tracklist is designed for playback of media content in a determined order.

6. The method of claim 1, wherein the at least one media item slot comprises a temporal slot for a media item to play back on a user device.

7. The method of claim 6, wherein the media item comprises a media file containing text, graphics, audio, video, executable code, or any combination thereof.

8. The method of claim 1, wherein the at least one invitational content slot comprises a temporal slot for an invitational content item to play back on a user device.

9. The method of claim 8, wherein the invitational content item comprises a media file containing text, graphics, audio, video, executable code, or any combination thereof.

10. A computer-readable medium storing computer executable instructions for causing a computer to perform the method comprising:
receiving, via a user device, a tracklist, wherein the tracklist comprises at least one media item slot and at least one invitational content slot;
receiving, via the user device, a list of slot properties for the at least one invitational content slot;
determining, via a slot optimization engine, an invitational content item for placement in each invitational content slot within the tracklist, wherein the determining is based on the slot properties and a set of slot optimization rules for placing invitational content within invitational content slots; and
transmitting the determined invitational content items to a client device.

11. The method of claim 10, wherein the list of slot properties for the at least one invitational content slot comprises genre descriptions of the media item slots adjacent to the invitational content slot.

12. The method of claim 10, wherein the set of slot optimization rules comprises rules for associating invitational content with genres of media items.

13. The method of claim 10, wherein the transmitting the determined invitational content items to a client device comprises generating and assembling a content package containing the invitational content items for playback on the client device.

14. The method of claim 10, wherein the tracklist is a sequence of ordered slots for media items and invitational content, and wherein the tracklist is designed for playback of media content in a determined order.

15. The method of claim 10, wherein the at least one media item slot comprises a temporal slot for a media item to play back on a user device.

16. The method of claim 10, wherein the at least one invitational content slot comprises a temporal slot for an invitational content item to play back on a user device.

17. A computer implemented method comprising:
receiving on a user device, via a content management server, at least one media item;
generating a tracklist on the user device containing the at least one media item, wherein the tracklist is a sequence of ordered slots for media items and invitational content, and wherein the tracklist is designed for playback of media content in a determined order;
determining at least one invitational content slot for the tracklist, wherein the determining is based on a set of tracklist rules and the content properties of the at least one media item;
transmitting information about the tracklist and the at least one invitational content slot to the content management server.

18. The method of claim 17, wherein the set of tracklist rules comprises rules for placing invitational content slots within a sequence of media items.

19. The method of claim 17, wherein the transmitting information about the tracklist and the at least one invitational content slot comprises transmitting information about the genres of the media items within the tracklist.

20. The method of claim 17, wherein the determining at least one invitational content slot for the tracklist comprises associating the content properties of the at least one media item with the content properties of the invitational content slot.

21. The method of claim 17, further comprising:
determining a set of preferences for invitational content; and
transmitting the set of preferences for invitational content to the content management server.

22. A product comprising:
a computer readable medium; and
computer readable instructions, stored on the computer readable medium, that when executed are effective to cause a computer to:
receive, via a user device, a tracklist, wherein the tracklist is a sequence of ordered slots for media items and invitational content, and wherein the tracklist comprises at least one media item slot and at least one invitational content slot;
receive, via the user device, a list of slot properties for the at least one invitational content slot, wherein the list of slot properties comprises genre descriptions of the media item slots adjacent to the invitational content slot;
determine, via a slot optimization engine, an invitational content item for placement in each invitational content slot within the tracklist, wherein the determining is based on the slot properties and a set of slot optimization rules for placing invitational content within invitational content slots, and wherein the set of slot optimization rules comprises rules for associating invitational content with genres of media items; and
transmit the determined invitational content items to a client device, wherein the transmitting comprises generating and assembling a content package containing the invitational content items for playback on the client device.

23. The method of claim 22, wherein the at least one media item slot comprises a temporal slot for a media item to play back on a user device.

24. The method of claim 23, wherein the media item comprises a media file containing text, graphics, audio, video, executable code, or any combination thereof.

25. The method of claim 22, wherein the at least one invitational content slot comprises a temporal slot for an invitational content item to play back on a user device.
